(19) United States
(12) Patent Application Publication
(10) Pub. No.: US 2025/0132488 A1
(43) Pub. Date: Apr. 24, 2025

(54) ELECTRONIC DEVICE AND ANTENNA STRUCTURE

(71) Applicant: WISTRON NEWEB CORPORATION, HSINCHU (TW)

(72) Inventors: CHIA-HAO CHANG, HSINCHU (TW); CHUNG-CHE LIEN, HSINCHU (TW); TING-HAN SHIH, HSINCHU (TW); TZU-KUAN SUN, HSINCHU (TW)

(21) Appl. No.: 18/916,886

(22) Filed: Oct. 16, 2024

(30) Foreign Application Priority Data
Oct. 19, 2023 (TW) 112139871

(51) Int. Cl. H01Q 1/22; H01Q 1/48; H01Q 5/307

(52) U.S. Cl. CPC H01Q 1/2266; H01Q 1/48; H01Q 5/307

(57) ABSTRACT

An electronic device and an antenna structure are provided. The electronic device includes a housing and an antenna structure which includes a first radiating element with a first radiating part, a feed part, and a grounding part, a second radiating element with five branches, a grounding element connected to the grounding part, a feed element connected to the feed part, a switching circuit electrically connected to the third branch, and a proximity sensing circuit electrically connected to the fourth branch. The first branch and the second branch intersect at a first branching point, the third branch and the fourth branch intersect at a second branching point. The fifth branch is connected between the first branching point and the second branching point. The first radiating part extends between the first branch and the second branch so the first radiating part and the second radiating element couple with each other.

### CROSS-REFERENCE TO RELATED PATENT APPLICATION

This application claims the benefit of priority to Taiwan Patent Application No. 112139871, filed on Oct. 19, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. references cited and discussed in this specification are incorporated herein by reference in their entireties and to the same extent as if each reference was individually incorporated by reference.

### FIELD OF THE DISCLOSURE

The present disclosure relates to an electronic device and an antenna structure, and more particularly to an electronic device and an antenna structure having an operating frequency band used by the fifth-generation mobile networks (5G).

### BACKGROUND OF THE DISCLOSURE

Existing electronic products, such as notebook computers and tablet computers, tend to have a slim and lightweight design. However, with the development of fifth-generation mobile networks (5G), the internal space available for accommodating antennas in existing electronic products is limited, resulting in the designed antenna structure having insufficient bandwidth issues.

So, how to solve the aforementioned deficiency through improving the structural design of the antenna structure has become an issue to be overcome.

### SUMMARY OF THE DISCLOSURE

In response to the above-referenced technical inadequacy, the present disclosure provides an antenna structure and an electronic device to solve the technical issue of an antenna structure deficient in bandwidth due to insufficient space for antenna placement in existing electronic devices.

In one aspect, the present disclosure provides an electronic device, which includes a housing and an antenna structure. The antenna structure is arranged in the housing. The antenna structure includes a first radiating element, a second radiating element, a grounding element, a feed element, a switching circuit, and a proximity sensing circuit. The first radiating element includes a first radiating part, a feed part, and a grounding part. The feed part and the grounding part are connected to the first radiating part. The second radiating element includes a first branch, a second branch, a third branch, a fourth branch, and a fifth branch. The first branch and the second branch extend in a first direction, and the third branch and the fourth branch extend in a second direction. The first direction is different from the second direction. The first branch and the second branch intersect at a first branching point, and the third branch and the fourth branch intersect at a second branching point. One end of the fifth branch is connected to the first branching point, and another end of the fifth branch is connected to the second branching point. The first radiating part extends between the first branch and the second branch, so that the first radiating part and the second radiating element couple with each other. The grounding element is connected to the grounding part. The feed element has a signal end and a ground end, the signal end is connected to the feed part, and the ground end is connected to the grounding element. The switching circuit is electrically connected to the third branch. The proximity sensing circuit is electrically connected to the fourth branch.

In another aspect, the present disclosure provides an antenna structure, which includes a first radiating element, a second radiating element, a grounding element, a feed element, a switching circuit, and a proximity sensing circuit. The first radiating element includes a first radiating part, a feed part, and a grounding part. The feed part and the grounding part are connected to the first radiating part. The second radiating element includes a first branch, a second branch, a third branch, a fourth branch, and a fifth branch. The first branch and the second branch extend in a first direction, and the third branch and the fourth branch extend in a second direction. The first direction is different from the second direction. The first branch and the second branch intersect at a first branching point, and the third branch and the fourth branch intersect at a second branching point. One end of the fifth branch is connected to the first branching point, and another end of the fifth branch is connected to the second branching point. The first radiating part extends between the first branch and the second branch, so that the first radiating part and the second radiating element couple with each other. The grounding element is connected to the grounding part. The feed element has a signal end and a ground end, the signal end is connected to the feed part, and the ground end is connected to the grounding element. The switching circuit is electrically connected to the third branch. The proximity sensing circuit is electrically connected to the fourth branch.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an electronic device of the present disclosure;

FIG. 2 is a perspective schematic diagram of an antenna structure according to the present disclosure;

FIG. 3 is a schematic diagram of an antenna structure according to the present disclosure;

FIG. 4 is a schematic diagram of a first radiating part, a second radiating element, a switching circuit, and a proximity sensing circuit of an antenna structure according to the present disclosure; and

FIG. 5 is a schematic diagram illustrating the reflection loss curve of an antenna structure according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In addition, the term “or”, as used herein, should include any one or a combination of the associated enlisted items, as the case may be. The term “connect” in the context of the present disclosure means there is a physical connection between two elements and is directly or indirectly connected. The term “couple” in the context of the present disclosure means there is no physical connection between two separated elements, and the two elements are instead connected by their electric field energy where the electric field energy generated by the current of one element excites the electric field energy of the other element.

### Embodiment

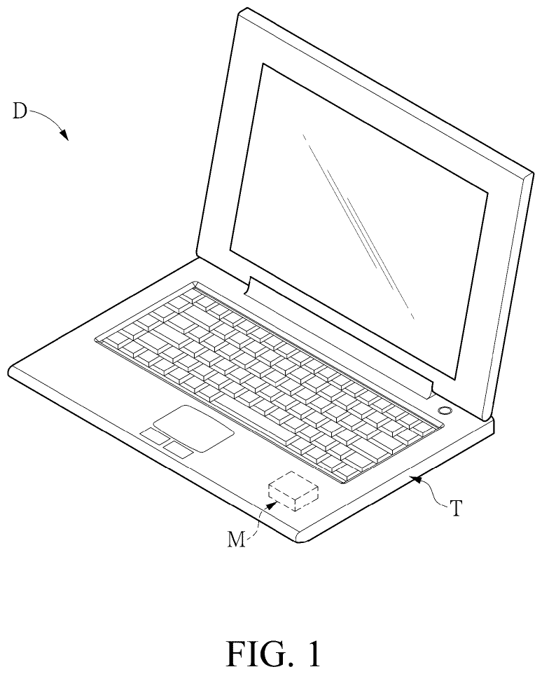

Referring to FIG. 1, FIG. 1 is a schematic diagram of an electronic device D according to the present disclosure. The electronic device D includes a housing T and an antenna structure M arranged in the housing T. The electronic device D can be a smartphone, a tablet computer, or a notebook computer, and the present disclosure is not limited thereto. The present disclosure uses a notebook computer as an example to illustrate the electronic device D. At least a portion of the housing T can be a metal housing. The electronic device D can generate at least one operating frequency band through the antenna structure M. Additionally, the present disclosure is not limited to the quantity and position of the antenna structure M in the electronic device D.

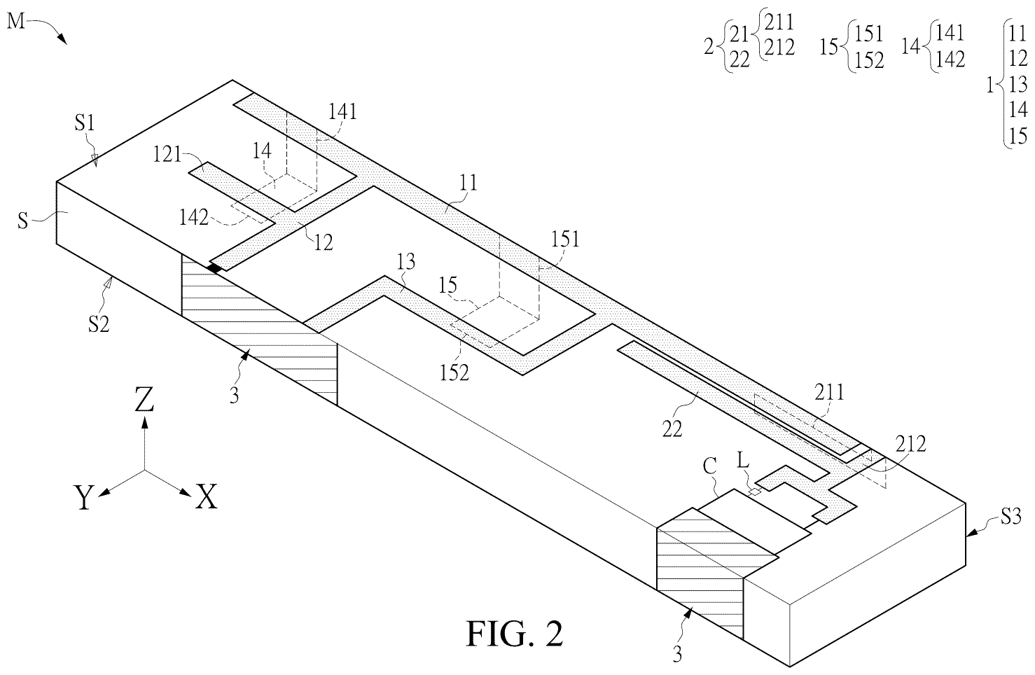

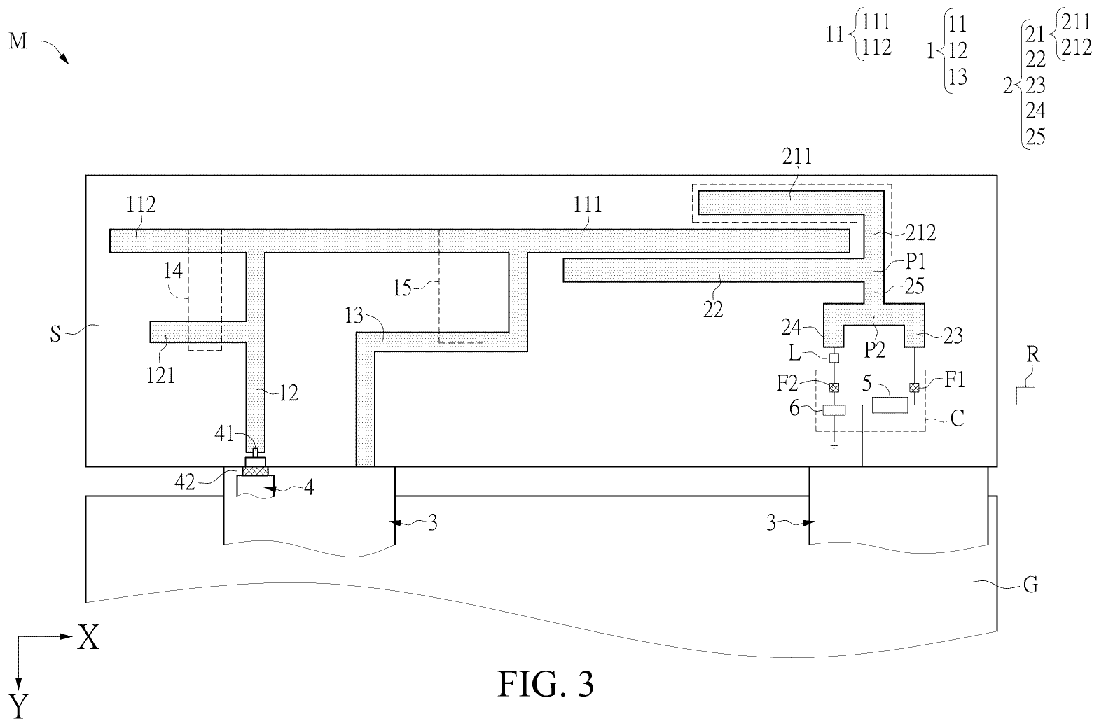

Referring to FIGS. 2 and 3, FIG. 2 is a perspective schematic diagram of the antenna structure M according to the present disclosure, and FIG. 3 is a schematic diagram of the antenna structure M according to the present disclosure. The antenna structure M includes a first radiating element 1, a second radiating element 2, a grounding element 3, a feed element 4, a switching circuit 5, and a proximity sensing circuit 6. The antenna structure M also includes a substrate S. For example, the substrate S can be an FR4 substrate, a printed circuit board, or a flexible printed circuit board. The first radiating element 1, the second radiating element 2, and the grounding element 3 can be metal sheets, metal wires, or other conductive materials with conductive effects. The feed element 4 can be a coaxial cable, but the present disclosure is not limited thereto.

It is to be noted that FIG. 2 shows the three-dimensional form of the antenna structure M, while FIG. 3 shows the planar form of the antenna structure M. To clearly present the shape of the first radiating element 1 and the second radiating element 2, the feed element 4 is omitted in FIG. 2. As shown in FIG. 2, the substrate S has a first surface S1 and a second surface S2, and a third surface S3 connecting the first surface S1 and the second surface S2. The first surface S1 and the second surface S2 are respectively located on opposite sides of the substrate S. The first radiating element 1 includes a first radiating part 11, a feed part 12, and a grounding part 13. The feed part 12 and the grounding part 13 are connected to the first radiating part 11. The first radiating part 11, the feed part 12, and the grounding part 13 are arranged on the first surface S1. Additionally, in the embodiment of the present disclosure, a part of the second radiating element 2 is arranged on the first surface S1, and another part of the second radiating element 2 is arranged on the third surface S3.

The grounding element 3 is connected to the grounding part 13. The grounding element 3 can be electrically connected to a metal element G, which can be a part of the housing T of the electronic device D, but the present disclosure is not limited thereto. The feed element 4 has a signal end 41 and a ground end 42. The signal end 41 is connected to the feed part 14, and the ground end 42 is connected to the grounding element 3. Thus, the first radiating element 1 forms an inverted-F antenna (PIFA) structure.

As shown in FIG. 3, the second radiating element 2 includes a first branch 21, a second branch 22, a third branch 23, a fourth branch 24, and a fifth branch 25. The first branch 21 and the second branch 22 extend in a first direction (negative X-axis direction). The third branch 23 and the fourth branch 24 extend in a second direction (positive Y-axis direction). The first direction is different from the second direction. Further, the first branch 21 and the second branch 22 intersect at a first branching point P1, and the third branch 23 and the fourth branch 24 intersect at a second branching point P2. One end of the fifth branch 25 is connected to the first branching point P1, and the other end of the fifth branch 25 is connected to the second branching point P2. Thus, the second radiating element 2 forms a bidirectional interdigitated (forked) structure.

The switching circuit 5 is electrically connected to the third branch 23, and the proximity sensing circuit 6 is electrically connected to the fourth branch 24. The first radiating part 11 extends between the first branch 21 and the second branch 22, so that the first radiating part 11 and the second radiating element 2 couple with each other, and cooperate with the switching circuit 5 to generate at least one operating frequency band. Furthermore, the present disclosure designs the structure of the first branch 21 and the second branch 22 extending in the same direction, so that when the first radiating part 11 and the second radiating element 2 are coupling with each other, the first branch 21 and the second branch 22 can be excited to generate a current path in the same direction, thereby increasing the matching effect between the first radiating part 11 and the second radiating element 2.

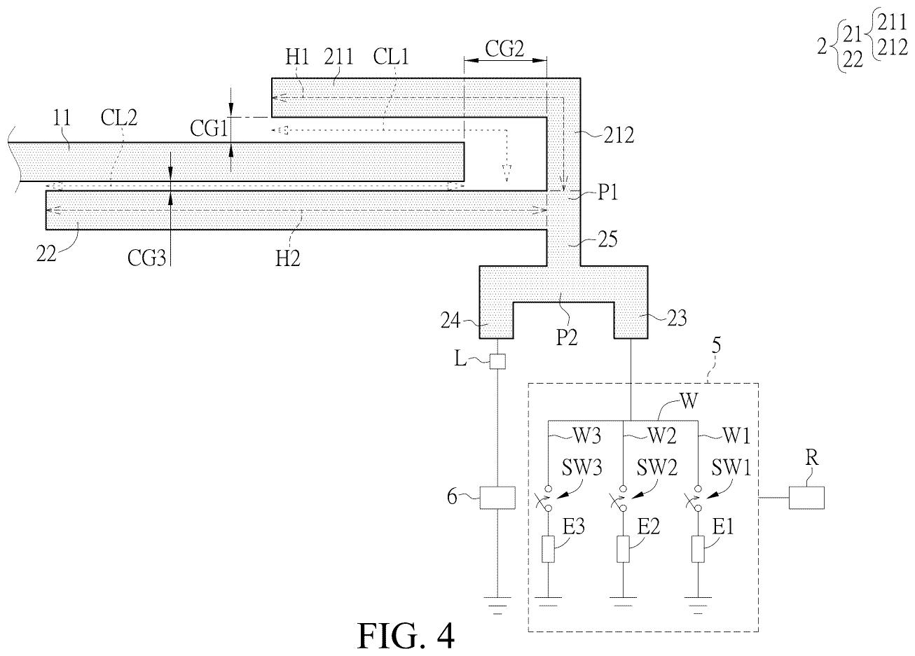

Referring to FIGS. 3 and 4, FIG. 4 is a schematic diagram of the first radiating part, the second radiating element, the switching circuit, and the proximity sensing circuit of the antenna structure according to the present disclosure. As shown in FIG. 4, the length H1 of the first branch 21 and the length H2 of the second branch 22 are not equal. The length H1 of the first branch 21 is the extension distance from the first branching point P1 to the open end of the first arm 211, and the length H2 of the second branch 22 is the extension distance from the first branching point P1 to the open end of the second branch 22. The first radiating part 11 and the first branch 21 are separate from each other and couple with each other to generate a first operating frequency band with a frequency range in LTE Band 5. The first radiating part 11 and the second branch 22 are separate from each other and couple with each other to generate a second operating frequency band with a frequency range in LTE Band 71. The first operating frequency band is higher than the second operating frequency band. Further, as shown in FIG. 4, the coupling length CL1 between the first radiating part 11 and the first branch 21 is equal to a quarter of a wavelength of the center frequency of the first operating frequency band. The coupling length CL2 between the first radiating part 11 and the second branch 22 is equal to a quarter of a wavelength of the center frequency of the second operating frequency band. It should be noted that the term “coupling length” here does not refer to the length of the element but to the effective length of the part of the antenna element used to produce the coupling effect.

As shown in FIG. 3, the first radiating part 11 includes a first section 111 and a second section 112, with the feed part 12 connected between the first section 111 and the second section 112, and the grounding part 13 connected to the first section 111. The first section 111 extends between the first branch 21 and the second branch 22. The first radiating element 1 receives a signal fed through the feed part 12, causing the first section 111 and the feed part 12 to be excited and generate a third operating frequency band with a frequency range between 1500 MHz and 3000 MHz.

As shown in FIG. 3 and FIG. 4, the first branch 21 includes a first arm 211 and a second arm 212. One end of the second arm 212 is connected to the first arm 211, and the other end of the second arm 212 is connected to the first branching point P1. The first arm 211 and the first radiating part 11 have a first coupling distance CG1 between them, and the second arm 212 and the first radiating part 11 have a second coupling distance CG2 between them. The second coupling distance CG2 is greater than the first coupling distance CG1.

Furthermore, the second branch 22 and the first radiating part 11 have a third coupling distance CG3 between them, where the third coupling distance CG3 is less than the first coupling distance CG1 and also less than the second coupling distance CG2. Preferably, the first coupling distance CG1 is 1.5 mm, the second coupling distance CG2 is greater than 5 mm, and the third coupling distance CG3 is 0.2 mm.

As shown in FIG. 2 and FIG. 3, the first radiating element 1 also includes a second radiating part 14 and a third radiating part 15. The second radiating part 14 and the third radiating part 15 are arranged on the second surface S2. A first end 141 of the second radiating part 14 and a first end 151 of the third radiating part 15 are connected to the first radiating part 11, while a second end 142 of the second radiating part 14 and a second end 152 of the third radiating part 15 extend from the third surface S3 to the second surface S2. However, the above-mentioned examples are only one feasible implementation of the present disclosure and are not intended to limit the present disclosure. Specifically, the second radiating part 14 can be connected to the second section 112, and the third radiating part 15 can be connected to the first section 111. The vertical projections of the second radiating part 14 and the third radiating part 15 on the first surface S1 partially overlap with the feed part 12 and the grounding part 13, respectively.

The feed part 12 includes an arm 121, and the second radiating part 14 and the arm 121 couple to generate a third operating frequency band with a frequency range between 4200 MHz and 5000 MHz. The third radiating part 15 and the grounding part 13 couple to generate a fourth operating frequency band with a frequency range between 5000 MHz and 6000 MHz. The fourth operating frequency band is higher than the third operating frequency band.

It is to be noted that, since the feed part 12 and the grounding part 13 are arranged on the first surface S1, and the second radiating part 14 and the third radiating part 15 are arranged on the second surface S2, the coupling amount between the second radiating part 14 and the arm 121, as well as the coupling amount between the third radiating part 15 and the grounding part 13, will be related to the thickness of the substrate S (i.e., the distance between the first surface S1 and the second surface S2). In the present disclosure, the thickness of the substrate S is less than 3 mm, preferably 1.5 mm.

As shown in FIG. 3 and FIG. 4, the switching circuit 5 is a part of the multifunctional integrated module C. The second radiating element 2 can be electrically connected to one of the pins F1 of the integrated module C through the third branch 23, and then electrically connected to the switching circuit 5 through the pin F1. Additionally, the second radiating element 2 can be electrically connected to another pin F2 of the integrated module C through the fourth branch 24, and then electrically connected to the proximity sensing circuit 6 through the pin F2. The antenna structure also includes an inductive element L, which is connected between the fourth branch 24 and the proximity sensing circuit 6. It should be noted that, in the embodiment of the present disclosure, the inductive element L is located outside the integrated module C, but the present disclosure is not limited thereto. In other implementations, the inductive element L can also be integrated into the integrated module C. Preferably, the inductance value of the inductive element L is 33 nH.

As shown in FIG. 4, the switching circuit 5 includes a signal transmission path W and at least one transmission path. The signal transmission path W is electrically connected to the third branch 23. The at least one transmission path is electrically connected to the signal transmission path W, and the at least one transmission path is respectively connected to at least one passive element. The present disclosure is not limited to the number of transmission paths. For example, the switching circuit 5 can include three transmission paths, respectively being the first path W1, the second path W2, and the third path W3, which are electrically connected to the signal transmission path W.

The first path W1 is connected in series with a first passive element E1 and a first switch SW1, the second path W2 is connected in series with a second passive element E2 and a second switch SW2, and the third path W3 is connected in series with a third passive element E3 and a third switch SW3. Additionally, in the present disclosure, the first passive element E1, the second passive element E2, and the third passive element E3 can be inductors, capacitors, or resistors, and the present disclosure is not limited thereto. For example, the first passive element E1, the second passive element E2, and the third passive element E3 can all be capacitors, with capacitance values of 47 pF, 56 pF, and 68 pF, respectively. Therefore, the electronic device D can utilize the setup of the first passive element E1, the second passive element E2, and the third passive element E3 to adjust the operating frequency band, impedance matching, and radiation efficiency of the antenna structure M.

The electronic device D can further include a control circuit R. The control circuit R can control the switching circuit 5 to switch among multiple modes to adjust the operating frequency band of the antenna structure M, enabling the antenna structure M to cover a broader frequency range in low-frequency bands. For example, the control circuit R can control the switching circuit 5 to switch among the first mode, the second mode, the third mode, and the fourth mode. The first mode is when the second radiating element 2 is electrically connected to the control circuit R, and the first to third switches SW1 to SW3 on the first to third paths W1 to W3 are in a non-conductive state. The second mode is when the second radiating element 2 is grounded through the first path W1, with the first switch SW1 on the first path W1 being in a conductive state, while the second and third switches SW2 and SW3 on the second and third paths W2 and W3 are in a non-conductive state. The third mode is when the second radiating element 2 is grounded through the second path W2, with the second switch SW2 on the second path W2 being in a conductive state, while the first and third switches SW1 and SW3 on the first and third paths W1 and W3 are in a non-conductive state. The fourth mode is when the second radiating element 2 is grounded through the third path W3, with the third switch SW3 on the third path W3 being in a conductive state, while the first and second switches SW1 and SW2 on the first and second paths W1 and W2 are in a non-conductive state.

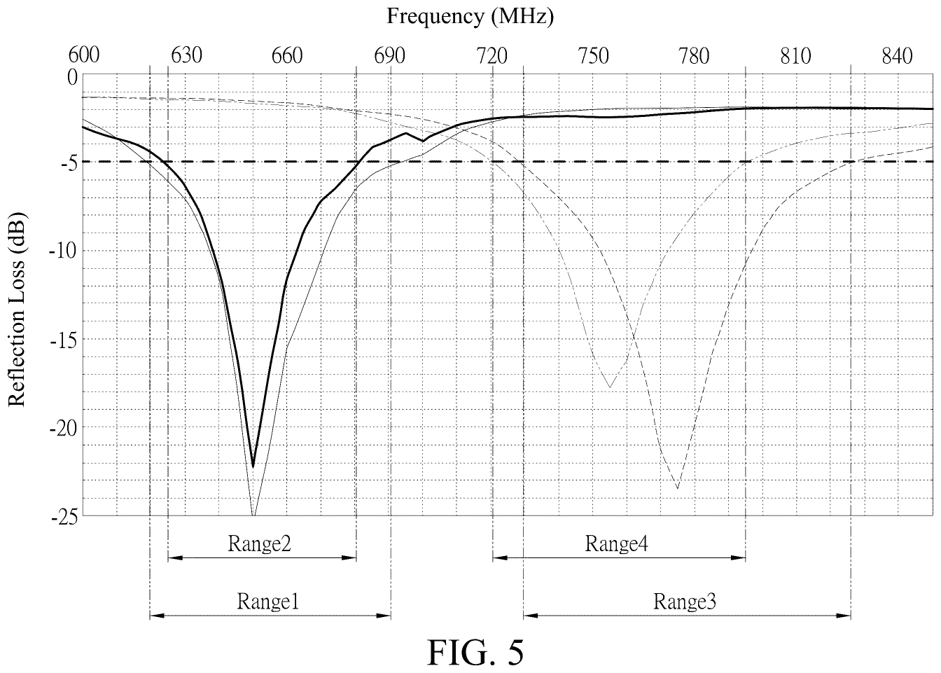

Referring to FIG. 5, FIG. 5 is a schematic diagram illustrating the reflection loss curve of the antenna structure according to the present disclosure. Frequency range 1 (Range 1) and frequency range 3 (Range 3) represent the bandwidth of the antenna structure M of the present disclosure with the second radiating element 2 adopting a bidirectional interdigitated structure in the low-frequency range. Frequency range 2 (Range 2) and frequency range 4 (Range 4) represent the bandwidth of the antenna structure in the low-frequency range using existing technology. Furthermore, frequency range 1 (Range 1) and frequency range 2 (Range 2) are within the second operating frequency band (LTE Band 71), and frequency range 3 (Range 3) and frequency range 4 (Range 4) are within the first operating frequency band (LTE Band 5).

From FIG. 5, it can be seen that the bandwidth of the antenna structure of the existing technology in LTE Band 71 is about 55 MHZ (625 MHz to 680 MHz), and the bandwidth in LTE Band 5 is about 75 MHz (720 MHz to 795 MHz). In contrast, the bandwidth of the antenna structure M of the present disclosure in LTE Band 71 is about 70 MHz (620 MHz to 690 MHz), and the bandwidth in LTE Band 5 is about 95 MHz (730 MHz to 825 MHz). Therefore, the antenna structure M of the present disclosure, when the second radiating element 2 adopts a bidirectional interdigitated structure, produces a significantly better operating frequency band in the low-frequency range. Compared to existing antenna structures, the bandwidth of the antenna structure M of the present disclosure in LTE Band 71 increases by 25%, and the bandwidth in LTE Band 5 increases by 25%. Additionally, compared to existing antenna structures, the antenna structure M of the present disclosure can further increase the frequency offset by 20 MHz.

Furthermore, the present disclosure can use the proximity sensing circuit 6 electrically connected to the fourth branch 24 of the second radiating element 2 to treat the second radiating element 2 as a sensor pad, providing the proximity sensing circuit 6 to measure the distance between an object (such as a user's body part) and the antenna structure M. Thus, the electronic device D can have the function of sensing whether a human body is close to the antenna structure M, thereby adjusting the radiation performance of the antenna structure M to avoid the problem of excessive specific absorption rate (SAR) of electromagnetic wave energy by the biological body unit mass.

Moreover, in the present disclosure, since there is no electrical connection between the proximity sensing circuit 6 and the first radiating element 1, the first radiating element 1 used as a PIFA antenna can coexist with the second radiating element 2 used as a sensor pad for the proximity sensing circuit 6, thereby improving the antenna efficiency.

### Beneficial Effects of the Embodiments

One beneficial effect of the present disclosure is that the electronic device D and the antenna structure M provided by the present disclosure can form a bidirectional interdigitated structure for the second radiating element 2 through the technical solutions of “the first branch 21 and the second branch 22 of the second radiating element 2 intersecting at the first branch point P1, the third branch 23 and the fourth branch 24 of the second radiating element 2 intersecting at the second branch point,” “the first radiating part 11 extending between the first branch 21 and the second branch 22 to couple with the second radiating element 2,” and “the switching circuit 5 electrically connected to the third branch 23, and the proximity sensing circuit 6 electrically connected to the fourth branch 24.” Thus, the antenna structure M can be optimized without the need to use transmission lines and impedance matching elements to connect to the first radiating element 1, thereby improving the bandwidth, frequency offset, and antenna efficiency of the antenna structure M.

Furthermore, when the state of the second radiating element 2 of the antenna structure M of the present disclosure is adopted as a bidirectional interdigitated structure, the operating frequency band generated in the low-frequency range has significantly better bandwidth. Compared to existing antenna structures, the antenna structure M of the present disclosure increases the bandwidth by 25% in LTE Band 71 and by 25% in LTE Band 5. Additionally, compared to existing antenna structures, the antenna structure M of the present disclosure can further increase the frequency offset by 20 MHz.

Moreover, in the present disclosure, since there is no electrical connection between the proximity sensing circuit 6 and the first radiating element 1, the first radiating element 1 used as a PIFA antenna can coexist with the second radiating element 2 used as a sensor pad for the proximity sensing circuit 6, thereby improving antenna efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic device, comprising:
a housing; and
an antenna structure disposed in the housing, the antenna structure comprising:
a first radiating element, including a first radiating part, a feed part connected to the first radiating part, and a grounding part connected to the first radiating part;
a second radiating element, including a first branch, a second branch, a third branch, a fourth branch, and a fifth branch, the first branch and the second branch extending in a first direction, the third branch and the fourth branch extending in a second direction, the first direction being different from the second direction, the first branch and the second branch intersecting at a first branching point, the third branch and the fourth branch intersecting at a second branching point, one end of the fifth branch being connected to the first branching point, another end of the fifth branch being connected to the second branching point, the first radiating part extending between the first branch and the second branch, so that the first radiating part and the second radiating element couple with each other;
a grounding element, connected to the grounding part;
a feed element, having a signal end and a ground end, the signal end being connected to the feed part, the ground end being connected to the grounding element;
a switching circuit, electrically connected to the third branch; and
a proximity sensing circuit, electrically connected to the fourth branch.

2. The electronic device according to claim 1, wherein a length of the first branch and a length of the second branch are not equal.

3. The electronic device according to claim 2, wherein the first radiating part and the first branch are separate from each other and couple with each other to generate a first operating frequency band; wherein the first radiating part and the second branch are separate from each other and couple with each other to generate a second operating frequency band, the first operating frequency band being higher than the second operating frequency band; wherein a coupling length between the first radiating part and the first branch is equal to a quarter of a wavelength of a center frequency of the first operating frequency band, and a coupling length between the first radiating part and the second branch is equal to a quarter of a wavelength of a center frequency of the second operating frequency band.

4. The electronic device according to claim 3, wherein the first branch includes a first arm and a second arm, one end of the second arm is connected to the first arm, another end of the second arm is connected to the first branching point, a first coupling distance is defined between the first arm and the first radiating part, a second coupling distance is defined between the second arm and the first radiating part, and the second coupling distance is greater than the first coupling distance.

5. The electronic device according to claim 4, wherein a third coupling distance is defined between the second branch and the first radiating part, and the third coupling distance is less than the first coupling distance and the second coupling distance.

6. The electronic device according to claim 1, wherein the antenna structure further comprises a substrate, the substrate has a first surface and a second surface, the first surface and the second surface are located on opposite sides of the substrate, and the first radiating part, the feed part, the grounding part, and the second radiating element are disposed on the first surface.

7. The electronic device according to claim 6, wherein the first radiating element further comprises a second radiating part disposed on the second surface, the second radiating part is connected to the first radiating part, and a vertical projection of the second radiating part on the first surface partially overlaps with the feed part.

8. The electronic device according to claim 7, wherein the first radiating element further comprises a third radiating part disposed on the second surface, the third radiating part is connected to the first radiating part, and a vertical projection of the third radiating part on the first surface partially overlaps with the grounding part.

9. The electronic device according to claim 1, wherein the antenna structure further comprises an inductive element connected between the fourth branch and the proximity sensing circuit; wherein the switching circuit comprises a signal transmission path and at least one transmission path, the signal transmission path is electrically connected to the third branch, the at least one transmission path is electrically connected to the signal transmission path, and the at least one transmission path is respectively connected in series with at least one passive element.

10. An antenna structure, comprising:
a first radiating element, including a first radiating part, a feed part, and a grounding part, the feed part and the grounding part being connected to the first radiating part;
a second radiating element, including a first branch, a second branch, a third branch, a fourth branch, and a fifth branch, the first branch and the second branch extending in a first direction, the third branch and the fourth branch extending in a second direction, the first direction being different from the second direction, the first branch and the second branch intersecting at a first branching point, the third branch and the fourth branch intersecting at a second branching point, one end of the fifth branch being connected to the first branching point, another end of the fifth branch being connected to the second branching point, and the first radiating part extending between the first branch and the second branch, so that the first radiating part and the second radiating element couple with each other;
a grounding element, connected to the grounding part;
a feed element, having a signal end and a ground end, the signal end being connected to the feed part, the ground end being connected to the grounding element;
a switching circuit, electrically connected to the third branch; and
a proximity sensing circuit, electrically connected to the fourth branch.

11. The antenna structure according to claim 10, wherein a length of the first branch and a length of the second branch are not equal.

12. The antenna structure according to claim 11, wherein the first radiating part and the first branch are separate from each other and couple with each other to generate a first operating frequency band; wherein the first radiating part and the second branch are separate from each other and couple with each other to generate a second operating frequency band, the first operating frequency band being higher than the second operating frequency band; wherein a coupling length between the first radiating part and the first branch is equal to a quarter of a wavelength of a center frequency of the first operating frequency band, and a coupling length between the first radiating part and the second branch is equal to a quarter of a wavelength of a center frequency of the second operating frequency band.

13. The antenna structure according to claim 12, wherein the first branch includes a first arm and a second arm, one end of the second arm is connected to the first arm, another end of the second arm is connected to the first branching point, a first coupling distance is defined between the first arm and the first radiating part, a second coupling distance is defined between the second arm and the first radiating part, and the second coupling distance is greater than the first coupling distance.

14. The antenna structure according to claim 13, wherein a third coupling distance is defined between the second branch and the first radiating part, and the third coupling distance is less than the first coupling distance and the second coupling distance.

15. The antenna structure according to claim 10, further comprising a substrate, the substrate having a first surface and a second surface, the first surface and the second surface being located on opposite sides of the substrate, and the first radiating part, the feed part, the grounding part, and the second radiating element being disposed on the first surface.

16. The antenna structure according to claim 15, wherein the first radiating element further comprises a second radiating part disposed on the second surface, the second radiating part is connected to the first radiating part, and a vertical projection of the second radiating part on the first surface partially overlaps with the feed part.

17. The antenna structure according to claim 16, wherein the first radiating element further comprises a third radiating part disposed on the second surface, the third radiating part is connected to the first radiating part, and a vertical projection of the third radiating part on the first surface partially overlaps with the grounding part.

18. The antenna structure according to claim 10, further comprising an inductive element connected between the fourth branch and the proximity sensing circuit; wherein the switching circuit comprises a signal transmission path and at least one transmission path, the signal transmission path is electrically connected to the third branch, the at least one transmission path is electrically connected to the signal transmission path, and the at least one transmission path is respectively connected to at least one passive element.
